(19) United States
(12) Patent Application Publication
(10) Pub. No.: US 2024/0351433 A1
(43) Pub. Date: Oct. 24, 2024

(54) Multi-Axle Drive Unit for a Motor Vehicle, Motor Vehicle and Method for Operating the Motor Vehicle

(71) Applicant: Bayerische Motoren Werke Aktiengesellschaft, Muenchen (DE)

(72) Inventor: Philipp WOLFGRAMM, Muenchen (DE)

(21) Appl. No.: 18/640,123

(22) Filed: Apr. 19, 2024

(30) Foreign Application Priority Data
Apr. 20, 2023 (DE) 10 2023 110 038.6

(51) Int. Cl. B60K 17/356; B60K 17/16; B60K 23/08

(52) U.S. Cl. CPC B60K 17/356; B60K 17/16; B60K 23/08; B60K 2023/085

(57) ABSTRACT

A multi-axle drive unit includes an electric drive machine, a primary drive axle, a hydraulic device and a secondary drive axle. The primary drive axle has a primary axle drive element that is couplable to a rotor shaft of the electric drive machine mechanically directly or indirectly to thereby transmit torque. The hydraulic device has a hydraulic pump with a pump drive shaft which is couplable mechanically directly or indirectly to the rotor shaft. The secondary drive axle, on which a hydraulic motor of the hydraulic device is arranged, the hydraulic motor having a motor output shaft that is couplable to a secondary axle drive element of the secondary drive axle couplable mechanically directly or indirectly to thereby transmit torque, the hydraulic pump and the hydraulic motor being connected hydraulically to one another.

### CROSS REFERENCE TO RELATED APPLICATION

This application claims priority under 35 U.S.C. § 119 from German Patent Application No. DE 10 2023 110 038.6, filed Apr. 20, 2023, the entire disclosure of which is herein expressly incorporated by reference.

### BACKGROUND AND SUMMARY

The present disclosure relates to a multi-axle drive unit for a motor vehicle and to a purely electrically or hybrid-electrically drivable motor vehicle which is configured, in particular, as a passenger motor car. Furthermore, the disclosure relates to a method for operating the motor vehicle.

Current battery electric motor vehicles which have a multi-axle drive or all-wheel drive comprise two or more separate electric drive machines, for example one electric drive machine per drivable axle. In conjunction with their periphery, the two or more electric drive machines require a large amount of installation space and have to be integrated into the vehicle with consideration of packaging boundary conditions, which is often at the expense of an interior compartment volume, in particular a luggage compartment volume. Furthermore, it is particularly complex, in particular expensive, to use two or more electric drive machines, and a particularly high vehicle mass occurs on account of the mass of the second electric drive machine, which high vehicle mass prevents particularly energy-efficient and/or fuel-efficient and/or low-emission operation of the motor vehicle. Although it is conceivable to use merely one electric drive machine in conjunction with a transverse transfer case for an electrified multi-axle drive, installation space is then occupied by the transverse transfer case and additionally by shafts which run between the transverse transfer case and the drive axles, as a result of which the packaging problems would be exacerbated even further. In addition, it is necessary for an advantageously low overall center of gravity of the motor vehicle for the particularly heavy traction battery to be arranged as close as possible to the floor of the motor vehicle, as a result of which an installation space conflict would occur between the traction battery and the transverse transfer case and/or the shafts. Fully hydraulic drive concepts which manage without shafts between the front and rear axle for an all-wheel drive are known from the technical field of agricultural and forestry machines or construction machines, which move exclusively slowly, for example from DE 28 07 351 A1.

A multi-axle or all-wheel drive provides a safety increase only in certain driving situations; the driving tasks and driving situations which occur most frequently every day and with which a driver of a passenger motor car is usually confronted can be performed or managed safely by the driver without problems even without the use of an all-wheel drive, in particular with the aid of modern driving state stabilization systems (ABS, ESP, mentioning only two). Therefore, a further drive axle of the motor vehicle is often engaged nowadays, to be precise only when a controller of the motor vehicle has recognized that there is a driving situation which makes the use of the all-wheel drive necessary. As a result, however, the complexity of having to equip both axles of the motor vehicle with all-wheel technology is not decreased, and the packaging problem is not mitigated either.

DE 36 10 774 C1 proposes combining a vehicle axle with a purely internal combustion engine drive and a further vehicle axle with a hydrostatic drive in a motor vehicle. This conventional motor vehicle is particularly complicated, however. Moreover, the vehicle axle with a hydrostatic drive has to be connected manually, by means of a manual switch, for which reason the activation of the vehicle axle with a hydrostatic drive is incumbent on a driver of the conventional motor vehicle.

It is an object of the present disclosure to provide and to operate a particularly efficient and particularly easily usable multi-axle drive for a motor vehicle which can be integrated into the motor vehicle in a particularly simple and low-complexity manner.

This object is achieved by way of the subjects of the independent patent claims. Further possible refinements of the disclosure are disclosed in the subclaims, the description and the figures. Features, advantages and possible refinements which are shown within the context of the description for one of the subjects of the independent claims are to be considered, in a manner which spans across categories and embodiments, at least in an analogous manner as features, advantages and possible refinements of the respective subject matter of the other independent claims and of every possible combination of the subjects of the independent claims, possibly in conjunction with one or more of the subclaims.

According to the disclosure, a multi-axle drive unit for a motor vehicle is proposed which comprises an electric drive machine (in particular, only a single electric drive machine), a primary and a secondary drive axle, and a hydraulic device. In addition, the disclosure proposes a motor vehicle which is configured, in particular, as a passenger motor car and comprises the multi-axle drive unit as a constituent part. Furthermore, the disclosure includes a method for operating the multi-axle drive unit and the motor vehicle which comprises the multi-axle drive unit.

The primary drive axle which can be configured, for example, as a rear axle has a primary axle drive element, for instance a drive spur gear, a drive shaft, etc. The primary axle drive element and a rotor shaft of the electric drive machine are coupled mechanically directly or indirectly for the transmission of torque. For example, a rotor pinion which is seated fixedly on the rotor shaft for conjoint rotation and the drive spur gear mesh directly with one another. As an alternative, the rotor pinion and the drive spur gear can mesh indirectly with one another, for instance if a transmission unit with one transmission stage or a plurality of transmission stages, in particular a switchable transmission unit, is arranged between the rotor pinion and the drive spur gear. If the primary axle drive element is the drive shaft, it can be formed completely or in part by the rotor shaft or can be connected fixedly to the rotor shaft in a non-positive, positively locking and/or integrally joined manner for conjoint rotation. These definitions of “coupled directly” and “coupled indirectly” are to be applied to analogous passages of the present description and also apply analogously to “can be coupled directly”, “can be coupled indirectly” and similar wordings.

The hydraulic device of the multi-axle drive unit has a hydraulic pump, the pump drive shaft of which is coupled or can be coupled mechanically directly or indirectly to the rotor shaft. In particular, the hydraulic device can be switched into a first operating mode or can be operated in the latter, in which the pump drive shaft and the rotor shaft are decoupled from one another, with the result that they can be rotated freely relative to one another. In this state, the pump drive shaft and the rotor shaft can be coupled to one another. Furthermore, the hydraulic device can be switched, in particular, into a second operating mode or can be operated in the latter, in which the pump drive shaft and the rotor shaft are coupled to one another, with the result that the pump drive shaft is driven or rotated on account of a rotation of the rotor shaft. On the secondary drive axle which is arranged and configured separately from the primary drive axle, the hydraulic device has a hydraulic motor, the motor output shaft of which and a secondary axle drive element (for instance, a further drive spur gear or a further drive shaft) of the secondary drive axle are coupled or can be coupled mechanically directly or indirectly for the transmission of torque, the hydraulic pump and the hydraulic motor being connected hydraulically to one another. By the hydraulic pump and the hydraulic motor being connected hydraulically to one another, for example by means of a hydraulic fluid circuit, the hydraulic motor can be driven hydraulically by means of the hydraulic pump. It is provided here, in particular, that a pumping direction of the hydraulic pump can be changed or switched over, for example by way of a rotational direction reversal and/or by means of a valve device, in order to make both reverse driving and forward driving with the motor vehicle possible.

Thanks to the multi-axle drive unit, a particularly efficient and particularly simply usable multi-axle drive for a motor vehicle is provided. This is because a single electric drive machine is firstly sufficient to provide the all-wheel or multi-axle drive functionality, as a result of which mass and installation space requirements of a further electric drive machine are dispensed with. In addition, no tunnel which runs through the multi-axle drive unit in the longitudinal direction (x) of the motor vehicle is to be provided for shafts or the like, since the hydraulic coupling between the hydraulic motor and the hydraulic pump can take place by means of a flexibly designable channel, pipe and/or hose system which does not require a straight connection between the hydraulic motor and the hydraulic pump. This is of immense advantage, in particular, with regard to a traction battery which is particularly intensive in terms of installation space, since this can be bypassed on the upper side, on the lower side and/or laterally by means of the channel, pipe and/or hose system. In this regard, the multi-axle drive unit can also be integrated in a particularly simple and low-complexity manner into the motor vehicle.

The motor vehicle, that is to say the passenger motor car, can be operated in accordance with the method according to the disclosure on the basis of the multi-axle drive unit. This means that the multi-axle drive unit and/or the motor vehicle are/is configured for carrying out the method. In particular, the motor vehicle or the multi-axle drive unit comprises a control and sensor unit which is configured to detect driving state data of the motor vehicle which characterize a current driving state of the motor vehicle. The driving state data comprise, in particular, one or more of the following information items: a driving speed, a longitudinal acceleration, a lateral acceleration, a yaw acceleration, a pitch acceleration, a roll acceleration, rotational speeds and/or rotational differences of the wheels (tires/rim combinations), a roadway state or roadway surface (uphill slope, downhill slope, asphalt, loose chippings, snow, wet conditions, ice, etc.), a weather condition (precipitation, temperature, etc.), vehicle settings performed by the user (sport mode, comfort mode, etc.), driving requests input by the user (speed increase request, speed decrease request or braking, steering wheel angle) and the like. Furthermore, the control and sensor unit is configured to control the multi-axle drive unit, in particular the hydraulic device thereof.

In the case of the method, the driving state of the motor vehicle is detected by means of the control and sensor unit of the motor vehicle. Furthermore, based on the detected driving state, the multi-axle drive unit, in particular the hydraulic device thereof, is switched, in particular automatically, by means of the control and sensor unit, into an operating mode, in which the secondary drive axle is driven by means of the hydraulic device up to a predefined driving speed of the motor vehicle, that is to say, for example, into the second operating mode. The predefined driving speed is, in particular, 50 km/h. In this way, a multi-axle drive functionality is produced which can be called a traction all-wheel system, since it is used or activated, in particular, only when a traction loss is impending or has occurred or a degree of traction is required which cannot be achieved my means of a pure single-axle drive. Here, a “performance all-wheel functionality”, that is to say a purely dynamics-increasing use of the multi-axle drive functionality, is dispensed with, especially since the multi-axle drive unit is not configured to this end on account of its hydraulic components. After corresponding development of currently available hydraulic components, however, a use of the multi-axle drive unit for dynamics-oriented applications in motor vehicles or passenger motor cars is not impossible.

In one possible development, the multi-axle drive unit comprises a hydraulic pump clutch which is connected mechanically directly or indirectly on one side to the pump drive shaft and on the other side to the rotor shaft. The pump clutch can be adjusted between a connected position and a disconnected position. In the connected position, the rotor shaft and the pump drive shaft are connected mechanically directly or indirectly to one another for the transmission of torque, whereas, in the disconnected position, the rotor shaft and the pump drive shaft can be rotated freely with respect to one another. As a result, a particularly simple and low-complexity solution is provided as to how the hydraulic device can be switched over between the first operating mode and the second operating mode. In addition, in the case of the secondary drive axle not being used, the hydraulic pump can be decoupled from the drive, with the result that it is not moved in a coupled manner in single-axle drive operation, that is to say, in an operation of the multi-axle drive unit, in which propulsion for the motor vehicle is generated merely by means of the primary drive axle. As a result, the single-axle drive operation is particularly efficient and low-loss.

In accordance with a further embodiment, the multi-axle drive unit has a hydraulic motor clutch which is connected mechanically directly or indirectly on one side to the motor output shaft and on the other side to the secondary axle drive element. The pump clutch can be adjusted between a connected position, in which the motor output shaft and the secondary axle drive element are connected mechanically directly or indirectly to one another for the transmission of torque, and a disconnected position, in which the motor output shaft and the secondary axle drive element can be rotated freely with respect to one another. As a result, a further particularly simple and low-complexity solution is provided as to how the hydraulic device can be switched over between the first operating mode and the second operating mode. In addition, in the case of the secondary drive axle not being used, not only the hydraulic pump but also the hydraulic motor can be decoupled from the drive, with the result that it is not moved in a coupled manner in single-axle drive operation. As a result, a concept of a particularly efficient and low-loss single-axle drive operation is taken into account to an even greater extent. The hydraulic pump clutch and/or the hydraulic motor clutch can be a respective clutch which acts in a frictionally locking and/or positively locking manner.

In accordance with a further possible refinement, the hydraulic pump is configured as an adjustable axial piston machine. As a result, a hydraulic fluid volumetric flow which is delivered to the hydraulic motor by means of the hydraulic pump can be regulated in a particularly simple and low-complexity manner, the hydraulic fluid volumetric flow no longer being determined only by a rotational speed of the rotor shaft and/or the pump drive shaft. Instead, the rotational speed of the motor output shaft of the hydraulic motor and, as a consequence, the drive speed of the secondary drive axle can be controlled by means of an adjustment of the hydraulic pump. Furthermore, it is possible in the case of this refinement for the pump clutch to be dispensed with, since the hydraulic pump can be adjusted into a neutral position, in which, although the displacer unit of the hydraulic pump is driven, no hydraulic fluid volumetric flow is delivered to the hydraulic motor. This aids the particularly simple construction of the multi-axle drive unit.

As an alternative or in addition, the hydraulic motor is configured as an adjustable axial piston machine. Thus, as an alternative or in addition to the possible omission of the pump clutch, the motor clutch can be dispensed with, as a result of which the construction of the multi-axle drive unit is even simpler. Furthermore, a hydraulic fluid volumetric flow which is delivered to the hydraulic motor by means of the hydraulic pump can be regulated in a particularly simple and low-complexity manner, it being possible for the hydraulic fluid volumetric flow to be set in a manner which is independent of a setting of the hydraulic pump. The rotational speed of the motor output shaft of the hydraulic motor and, as a consequence, the drive speed of the secondary drive axle can be controlled by means of an adjustment of the hydraulic motor.

By means of an adjustment of the hydraulic pump and/or the hydraulic motor into the neutral position, the multi-axle drive unit can be switched in a particularly simple manner, in particular without a clutch or the like, into the first operating mode, in which the secondary drive axle is deactivated. On account of an adjustment of the hydraulic pump and the hydraulic motor into a pump and motor position, respectively, which are different than the neutral position, the multi-axle drive unit is switched into the second operating mode, in which the secondary drive axle is activated.

It is provided in one possible development that the primary axle drive element and/or the secondary axle drive element are/is configured as a respective differential drive spur gear ring of an axle differential. This means that the primary drive axle has a primary axle differential and/or the secondary drive axle has a secondary axle differential. If the primary drive axle has the primary axle differential, the primary axle drive element is formed by way of its first differential drive spur gear ring of the primary axle differential. If the secondary drive axle has the secondary axle differential, the secondary axle drive element is formed by way of its second differential drive spur gear ring of the secondary axle differential. The respective axle differential has, for example, a bevel gear differential and/or a planetary gear differential.

For the case where the primary drive axle comprises the primary axle differential, a further possible embodiment provides that the first differential drive spur gear ring meshes firstly directly or indirectly with a rotor pinion which is seated fixedly on the rotor shaft for conjoint rotation, and meshes secondly directly or indirectly with a pump drive pinion which is seated fixedly on the pump drive shaft for conjoint rotation. If the pump clutch is provided, it can be arranged between the pump drive pinion and the hydraulic pump itself. For example, the pump drive shaft can have a pump-side shaft portion and a drive-side shaft portion which are selectively coupled fixedly to one another or decoupled from one another by means of the pump clutch. A transmission unit with one transmission stage or more transmission stages can generally be arranged between the first differential drive spur gear ring and the rotor pinion. Furthermore, a transmission unit of this type can be provided between the first differential drive spur gear ring and the pump drive pinion, the respective transmission unit being, in particular, a switchable gear mechanism. In this way, both the primary drive axle and (presupposing possibly a connected position of the pump clutch or a pump position which is different than the neutral position) the hydraulic pump are driven by means of the electric drive machine. As a result, the hydraulic motor is provided during driving operation with a hydraulic fluid volumetric flow which the hydraulic motor (presupposing possibly a connected position of the motor clutch or a motor position which is different than the neutral position) converts into propulsion at the secondary drive axle. The hydraulic pump can be positioned in a particularly flexible manner on account of the pump drive pinion which meshes with the first differential drive spur gear ring, since, apart from a meshing region, in which the rotor shaft pinion and the first differential drive spur gear ring engage into one another, the remaining circumference of the first differential drive spur gear ring is available for the meshing region, in which the first differential drive spur gear ring and the pump drive pinion engage into one another. Packaging demands can thus be reacted to in a particularly flexible and versatile manner.

It is provided in another possible embodiment that the rotor shaft and the pump drive shaft are coupled or can be coupled mechanically directly or indirectly to one another and without involvement of the primary axle drive element. For example, the rotor pinion and the pump drive pinion can mesh with one another directly or via a transmission unit, or the rotor shaft and the pump drive shaft are connected fixedly to one another directly for conjoint rotation. Furthermore, it can be provided that the rotor shaft and the pump drive shaft are realized together by way of a combined, in particular monolithic shaft. Since it can generally be provided that the rotor shaft and the primary axle drive element can be disconnected from one another, for example by means of a further clutch, a purely hydraulic drive can be provided in this embodiment which is advantageous, for instance, for crawl driving operation, maneuvering driving operation, et cetera. In particular, a speed change at low crawl speeds of this type can be metered by means of the hydraulic device in an improved and particularly jerk-free manner in comparison with by means of an electric drive machine.

If the secondary drive axle comprises the secondary axle differential, it is provided in accordance with a further possible embodiment that the second differential drive spur gear ring, that is to say that the secondary axle drive element meshes directly or indirectly with a motor output pinion which is seated fixedly on the motor output shaft for conjoint rotation. For the case where the motor clutch is provided, this can be arranged between the motor output pinion and the hydraulic motor itself. For example, the motor output shaft can have a motor-side shaft portion and an output-side shaft portion which are coupled selectively to one another fixedly for conjoint rotation or are decoupled from one another by means of the motor clutch.

Different variants are conceivable for the electric drive machine, for example, the electric drive machine can be arranged away from the primary drive axle and away from the secondary drive axle. Furthermore, the electric drive machine can be arranged in an axially parallel manner with respect to the drive axles. Furthermore, the electric drive machine can be integrated into the primary drive axle, for instance in a manner which is coaxial with respect to wheel drive shafts of the primary drive axle.

Further features of the disclosure can result from the claims, the figures and the description of the figures. The features and combinations of features which are mentioned above in the description and the features and combinations of features which are shown below in the description of the figures and/or only in the figures can be used not only in the respective specified combination, but rather also in other combinations or on their own, without departing from the scope of the disclosure.

Other objects, advantages and novel features of the present disclosure will become apparent from the following detailed description of one or more preferred embodiments when considered in conjunction with the accompanying drawings.

### BRIEF DESCRIPTION OF THE DRAWING

FIG. 1 shows a diagrammatic view of a motor vehicle 1 which comprises a multi-axle drive unit 2.

### DETAILED DESCRIPTION OF THE DRAWING

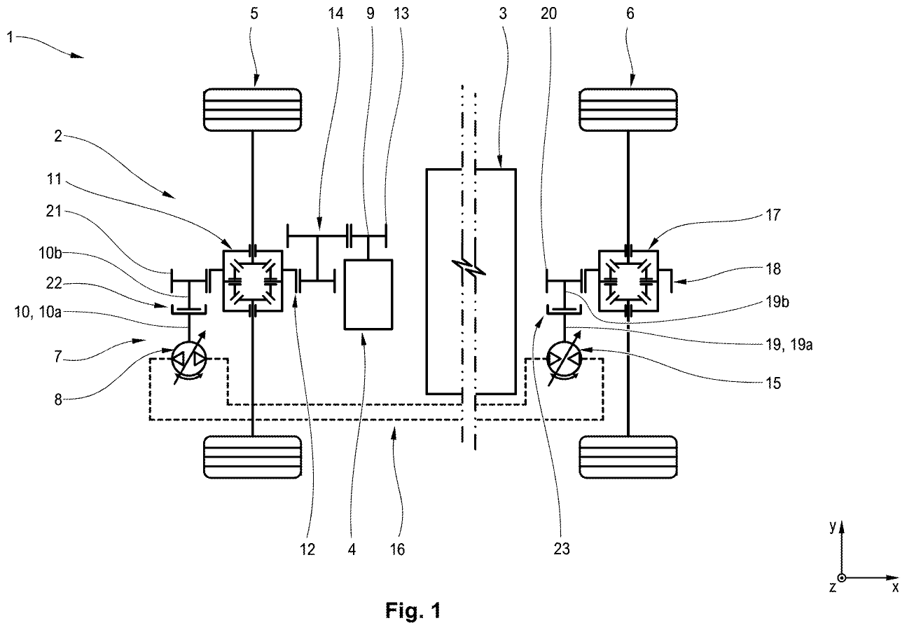

Identical and functionally identical elements are provided with an identical designation in FIG. 1. The following description relates not only to the motor vehicle 1 and the multi-axle drive unit 2, but rather also to a method for operating the motor vehicle 1 and the multi-axle drive unit 2.

In the present example, the motor vehicle 1 is a passenger motor car which can be driven in a purely electric or hybrid-electric manner. To this end, the passenger motor car 1 has a traction battery 3. The motor vehicle 1 or the passenger motor car 1 can be driven using all wheels and to this end has the multi-axle drive unit 2. The latter comprises precisely one electric drive machine 4, a primary drive axle 5 and a secondary drive axle 6 and the electric drive machine 4. In the present case, a rear axle of the motor vehicle 1 is formed by way of the primary drive axle 5, whereas a front axle of the motor vehicle 1 is formed by way of the secondary drive axle 6. A reversed arrangement is of course conceivable.

In addition, the multi-axle drive unit 2 comprises a hydraulic device 7 with a hydraulic pump 8 which is arranged close to the primary drive axle 5 and is configured in the present case as an adjustable axial piston pump, a rotor shaft 9 of the electric drive machine 4 and a pump drive shaft 10 of the hydraulic pump 8 being coupled mechanically directly or indirectly to one another, in such a way that the hydraulic pump 8 can be driven by means of the electric drive machine 4. In the example here, the primary drive axle 5 has a primary axle differential 11 which is configured merely by way of example as a bevel gear differential. Its first differential drive spur gear ring 12 forms a primary axle drive element of the primary drive axle 5. This and the rotor shaft 9 are coupled or can be coupled mechanically directly or indirectly for the transmission of torque. It is apparent from FIG. 1, for example, that the rotor shaft 9 supports a rotor pinion 13 which is fixed for conjoint rotation with the rotor shaft 9 and is in toothing engagement with the first differential drive spur gear ring 12, that is to say to the primary axle drive element, via a transmission unit 14 (that is to say, indirectly). Furthermore, the first differential drive spur gear ring 12 and a pump drive pinion 21 of the hydraulic pump 8 which is seated fixedly on the pump drive shaft 10 for conjoint rotation mesh with one another; in the present case, the first differential drive spur gear ring 12 and the pump drive pinion 21 mesh directly with one another, that is to say without a transmission unit which is active in between. In another embodiment, the rotor shaft 9 and the pump drive shaft 10 can be coupled or can be capable of being coupled to one another mechanically directly or indirectly and without involvement of the primary axle drive element or the first differential drive spur gear ring 12.

Furthermore, it can be gathered from FIG. 1 that the hydraulic device 7 comprises a hydraulic motor 15 which is arranged close to the secondary drive axle 6, is configured in the pre-sent case as an adjustable axial piston motor, and, like the hydraulic pump 8, is integrated into a hydraulic fluid circuit 16. The hydraulic pump 8 and the hydraulic motor 15 are connected to one another hydraulically by means of the hydraulic fluid circuit 16, in particular by means of its channel, pipe and/or hose system. By the hydraulic pump 8 and the hydraulic motor 15 being connected to one another hydraulically by means of the hydraulic liquid circuit 16, the hydraulic motor 15 can be driven hydraulically by means of the hydraulic pump 8. Here, the channel, pipe and/or hose system of the hydraulic fluid circuit 16 by-pass/bypasses the traction battery 3 on the upper side, on the lower side and/or laterally.

In the example here, the secondary drive axle 6 has a secondary axle differential 17 which is configured merely by way of example as a further bevel gear differential. Its second differential drive spur gear ring 18 forms a secondary axle drive element of the secondary drive axle 6. This and a motor output shaft 19 of the hydraulic motor 15 are coupled or can be coupled mechanically directly or indirectly for the transmission of torque. In accordance with the present example, the motor output shaft 19 supports a motor output pinion 20 which is fixed for conjoint rotation in relation to the motor output shaft 19 and is in direct toothing engagement with the second differential drive spur gear ring 18, that is to say with the primary axle drive element.

FIG. 1 shows, furthermore, a hydraulic pump clutch 22 and a hydraulic motor clutch 23 which can each be adjusted or switched selectively into a connected position and into a disconnected position. The respective clutch 22, 23 is a clutch which acts in a frictionally locking or positively locking manner, for example a respective claw clutch. The hydraulic pump clutch 22 is connected mechanically directly or indirectly on one side to the pump drive shaft 10 and on the other side to the rotor shaft 9, in the present case, the hydraulic pump clutch 22 is integrated into the pump drive shaft 10. To this end, a first clutch side of the hydraulic pump clutch 22 and a pump-side shaft portion 10a of the pump drive shaft 10 are connected to one another fixedly for conjoint rotation, whereas a second clutch side of the hydraulic pump clutch 22 and a drive-side shaft portion 10b of the pump drive shaft 10 are connected to one another fixedly for conjoint rotation. The shaft portions 10a, 10b of the pump drive shaft 10 are then connected fixedly to one another for conjoint rotation by means of the hydraulic pump clutch 22 in its connected position, and are decoupled from one another in its disconnected position. As a consequence, in the connected position of the hydraulic pump clutch 22, the rotor shaft 9 and the pump drive shaft 10 are connected mechanically directly or indirectly to one another (here, via the pinions 13, 21, the primary axle drive element and the transmission unit 14) for the transmission of torque. In contrast, the shaft portions 10a, 10b are disconnected from one another in the disconnected position of the hydraulic pump clutch 22, as a result of which the rotor shaft 9 and the pump drive shaft 10 can be rotated freely with respect to one another.

The hydraulic motor clutch 23 is connected mechanically directly or indirectly on one side to the motor output shaft 19 and on the other side to the secondary drive axle element (that is to say, to the second differential drive spur gear ring 18 here); in the present case, the hydraulic motor clutch 23 is integrated into the motor output shaft 19. To this end, a first clutch side of the hydraulic motor clutch 23 and a motor-side shaft portion 19a of the motor output shaft 19 are connected to one another fixedly for conjoint rotation, whereas a second clutch side of the hydraulic motor clutch 23 and an output-side shaft portion 19b of the motor out-put shaft 19 are connected to one another fixedly for conjoint rotation. The shaft portions 19a, 19b of the motor output shaft 19 are thus connected to one another fixedly for conjoint rotation by means of the hydraulic motor clutch 23 in its connected position, and are decoupled from one another in its disconnected position. As a consequence, in the connected position of the hydraulic motor clutch 23, the motor output shaft 19 and the secondary axle drive element (that is to say, the second differential drive spur gear ring 18) are connected mechanically directly or indirectly (here, via the motor output pinion 20) to one another for the transmission of torque. In contrast, the shaft portions 19a, 19b are disconnected from one another in the disconnected position of the hydraulic motor clutch 23, as a result of which the motor output shaft 19 and the secondary axle drive element can be rotated freely with respect to one another.

The motor vehicle 1 or the passenger motor car 1 can be operated in accordance with the method on the basis of the multi-axle drive unit 2, for which reason the multi-axle drive unit 2 and/or the motor vehicle are/is configured to carry out the method. In the present case, the motor vehicle 1 or the multi-axle drive unit 2 has a control and sensor unit (not shown) which is configured firstly to detect driving state data of the motor vehicle 1 which characterize a current driving state of the motor vehicle 1. Secondly, the control and sensor unit is configured to control the multi-axle drive unit 2, in particular its hydraulic device 7. In the case of the method, the driving state of the motor vehicle 1 is therefore detected by means of the control and sensor unit. Based on the detected driving state, the multi-axle drive unit 2, in particular its hydraulic device 7, is switched, in particular automatically, by means of the control and sensor unit into an operating mode, in which the secondary drive axle 6 is driven by means of the hydraulic device 7 up to a predefined driving speed of the motor vehicle 1 (for example, up to 50 km/h).

The multi-axle drive unit 2 and the passenger motor car 1 indicate a respective possibility as to how a particularly efficient and particularly simply usable multi-axle drive for a motor vehicle can be provided which can be integrated in a particularly simple and low-complexity manner into the motor vehicle. The method illustrates a possibility as to how the multi-axle drive can be operated particularly efficiently. The core concept which forms the basis of the disclosure is the realization of a multi-axle or all-wheel drive by way of a hydraulic coupling of an electrically driven, first drive axle to a further drive axle of the motor vehicle. Here, in the case of the electrohydraulic all-wheel drive which is described in the present case, the further electric drive machine including its periphery is dispensed with on one of the drive axles in comparison with conventional, purely electric all-wheel drives. Instead, a hydraulic motor which is considerably more compact and, in particular, lighter on account of its greater power density than an electric drive machine of an identical, comparable power output is used on the drive axles which are free from an electric drive machine. For the transmission of the hydraulic power from the hydraulic pump to the hydraulic motor, hydraulic lines are routed laterally past the traction battery. Since hydraulic systems have a particularly low degree of efficiency at high speeds, that is to say at correspondingly high volumetric flows of the hydraulic fluid, the hydraulic pump and the hydraulic motor can be configured such that they can be decoupled (for example, with the aid of simple claw clutches). In this way, considerable traction advantages in comparison with a pure rear axle drive or a pure front axle drive are possible at low speeds, in particular up to a predefined or predefinable limit speed of, for example, 50 km/h and/or in the case of low coefficients of friction (wet conditions, snow). Nevertheless, an overall efficiency is considerably better than if the hydraulic all-wheel drive were permanently active.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

### LIST OF DESIGNATIONS

1 Motor vehicle or passenger motor car
2 Multi-axle drive unit
3 Traction battery
4 Electric drive machine
5 Primary drive axle
6 Secondary drive axle
7 Hydraulic device
8 Hydraulic pump
9 Rotor shaft
10 Pump drive shaft
11 Primary axle differential
12 First differential drive spur gear ring
13 Rotor pinion
14 Transmission unit
15 Hydraulic motor
16 Hydraulic fluid circuit
17 Secondary axle differential
18 Second differential drive spur gear ring
19 Motor output shaft
20 Motor output pinion
21 Pump drive pinion
22 Hydraulic pump clutch
23 Hydraulic motor clutch

What is claimed is:

1. A multi-axle drive unit for a motor vehicle, comprising:
an electric drive machine;
a primary drive axle having a primary axle drive element that is couplable to a rotor shaft of the electric drive machine mechanically directly or indirectly to thereby transmit torque;
a hydraulic device having a hydraulic pump with a pump drive shaft which is couplable mechanically directly or indirectly to the rotor shaft;
a secondary drive axle, on which a hydraulic motor of the hydraulic device is arranged, the hydraulic motor having a motor output shaft that is couplable to a secondary axle drive element of the secondary drive axle couplable mechanically directly or indirectly to thereby transmit torque, the hydraulic pump and the hydraulic motor being connected hydraulically to one another.

2. The multi-axle drive unit according to claim 1,
further comprising:
a hydraulic pump clutch which is connected mechanically directly or indirectly on one side to the pump drive shaft and on the other side to the rotor shaft, to thereby allow the pump clutch to be adjusted between a connected position, in which the rotor shaft and the pump drive shaft are connected mechanically directly or indirectly to one another to thereby transmit torque, and a disconnected position, in which the rotor shaft and the pump drive shaft are freely rotatable with respect to one another.

3. The multi-axle drive unit according to claim 2,
further comprising: a hydraulic motor clutch which is connected mechanically directly or indirectly on one side to the motor output shaft and on the other side to the secondary axle drive element, to thereby allow the pump clutch to be adjusted between a connected position, in which the motor output shaft and the secondary axle drive element are connected mechanically directly or indirectly to one another to thereby transmit torque, and a disconnected position, in which the motor output shaft and the secondary axle drive element are freely rotatable with respect to one another.

4. The multi-axle drive unit according to claim 1,
wherein
the hydraulic pump and/or the hydraulic motor are/is configured as a respective axial piston machine.

5. The multi-axle drive unit according to claim 1,
wherein
the primary axle drive element and/or the secondary axle drive element are/is configured as a respective differential drive spur gear ring of an axle differential.

6. The multi-axle drive unit according to claim 5,
wherein
the differential drive spur gear ring of the primary drive axle meshes firstly directly or indirectly with a rotor pinion which is seated fixedly on the rotor shaft to thereby conjointly rotate, and meshes secondly directly or indirectly with a pump drive pin-ion (21) which is seated fixedly on the pump drive shaft to thereby conjointly rotate.

7. The multi-axle drive unit according to claim 1,
wherein
the rotor shaft and the pump drive shaft are couplable mechanically directly or indirectly to one another and without involvement of the primary axle drive element.

8. The multi-axle drive unit according to claim 5,
wherein
the differential drive spur gear ring of the secondary drive axle meshes directly or indirectly with a motor output pinion which is seated fixedly on the motor output shaft to thereby conjointly rotate.

9. A passenger motor vehicle, with a multi-axle drive unit which is configured according to claim 1.

10. A method for operating a motor vehicle configured according to claim 9, wherein a driving state of the motor vehicle is detected via a control and sensor unit of the motor vehicle and, based on the detected driving state, the multi-axle drive unit being switched automatically, into an operating mode, in which the secondary drive axle is driven via the hydraulic device up to a predefined driving speed of the motor vehicle which is 50 km/h.
